(19) United States
(12) Patent Application Publication
(10) Pub. No.: US 2021/0051975 A1
(43) Pub. Date: Feb. 25, 2021

(54) CHICKPEA PROTEIN PRODUCTS AND METHODS OF MAKING THEREOF

(71) Applicant: INNOVOPRO LTD., Rishpon (IL)

(72) Inventors: Ascher SHMULEWITZ, Rishpon (IL); Gil DE PICCIOTTO, Zichron Yaacov (IL); Nitzan NATANI BEN CHAIM, Kibbutz Hatzor (IL)

(21) Appl. No.: 16/958,445

(22) PCT Filed: Dec. 28, 2017
(86) PCT No.: PCT/IB2017/001715

§ 371 Date: Jun. 26, 2020

(51) Int. Cl. A23J 1/14; A23L 27/60; A23L 29/10; A23L 11/00; A23L 2/66; A23G 9/38; A23L 9/10

(52) U.S. Cl. CPC A23J 1/14; A23L 27/60; A23L 29/10; A23V 2002/00; A23L 2/66; A23G 9/38; A23L 9/10; A23L 11/05

(57) ABSTRACT

In embodiments, the present invention is a mayonnaise emulsified food product that includes 60 wt % to 80 wt % of oil, based on a total weight of the mayonnaise emulsified food product, 10 wt % to 30 wt % of water, based on the total weight of the mayonnaise emulsified food product, wherein the oil and the water form an emulsion, 1 wt % to 5 wt % chickpea protein product, based on the total weight of the mayonnaise emulsified food product, where the chickpea protein product comprises at least 60 wt % protein based on a total weight of the chickpea protein product, where the chickpea protein product is an emulsifier, and optionally, at least one of vinegar, salt, lemon concentrate, or sugar.

### RELATED APPLICATION

This application claims the priority of U.S. provisional application Ser. No. U.S. Ser. No. 62/440,409, entitled “PROTEIN RICH CHICKPEA COMPOSITION AND USE THEREOF” filed Dec. 30, 2016, which is incorporated herein by reference in its entirety for all purposes.

### FIELD OF THE INVENTION

The present invention relates to a chickpea protein product, food products containing the chickpea protein product, and methods for preparing such products.

### BACKGROUND

The chickpea (Cicer arientum L.) is a legume having seeds high in protein. Legume (Pulse seed) proteins are vegan and offer an alternative for the production of food protein derived bioactive peptides.

A number of studies examined and demonstrated the health benefits related to chickpea supplementation to diet. The health benefits of eating legumes include, but are not limited to, improved glucose disposal through greater insulin sensitivity.

### BRIEF SUMMARY OF INVENTION

In embodiments, the present invention is a mayonnaise emulsified food product consisting essentially of:

60 wt % to 80 wt % of oil, based on a total weight of the mayonnaise emulsified food product;

10 wt % to 30 wt % of water, based on the total weight of the mayonnaise emulsified food product;

wherein the oil and the water form an emulsion; and

1 wt % to 5 wt % chickpea protein product, based on the total weight of the mayonnaise emulsified food product;

wherein the chickpea protein product comprises at least 60 wt % protein based on a total weight of the chickpea protein product;

wherein the chickpea protein product is an emulsifier; and

optionally, at least one of vinegar, salt, lemon concentrate, or sugar.

In other embodiments, the oil is present at 70 wt %, based on the total weight of the mayonnaise emulsified food product.

In yet other embodiments, the water is present at 20 wt %, based on the total weight of the mayonnaise emulsified food product.

In embodiments, the chickpea protein product is present at 1 wt % to 3 wt %, based on the total weight of the mayonnaise emulsified food product.

In embodiments, the chickpea protein product comprises 65 wt % to 90 wt % protein based on a total weight of the chickpea protein product.

In yet other embodiments, the vinegar is present at 2 wt % to 10 wt % of the mayonnaise emulsified food product.

In yet another embodiment, the sugar is present at 2 wt % to 8 wt % of the mayonnaise emulsified food product.

In embodiments, the mayonnaise emulsified food product is free of animal products.

In another embodiment, the present invention is an ice cream emulsified food product consisting essentially of:

4 wt % to 30 wt % fat, based on a total weight of the ice cream emulsified food product;

35 wt % to 80 wt % water, based on the total weight of the ice cream emulsified food product;

wherein the fat and the water form an emulsion;

0.05 wt % to 10 wt % chickpea protein product, based on a total weight of the ice cream emulsified food product;

wherein the chickpea protein product comprises at least 60 wt % protein based on a total weight of the chickpea protein product;

wherein the chickpea protein product is an emulsifier; and optionally, at least one of sugar, honey or syrup.

In embodiments, the fat is present at 10 wt % to 20 wt % based on the total weight of the ice cream emulsified food product.

In yet other embodiments, the water is present at 45 wt % to 60 wt %, based on the total weight of the ice cream emulsified food product.

In embodiments, the chickpea protein product is present at 1 wt % to 3 wt %, based on the total weight of the ice cream emulsified food product.

In yet other embodiments, the chickpea protein product comprises 65 wt % to 90 wt % protein based on a total weight of the chickpea protein product.

In other embodiments, the ice cream emulsified food product is free of animal products.

In an embodiment, the present invention is an emulsified food product consisting essentially of:

water;

at least one of oil or fat;

wherein the at least one of oil and fat and the water form an emulsion;

1 wt % to 12 wt % chickpea protein product, based on a total weight of the food product;

wherein the chickpea protein product comprises at least 60 wt % protein based on a total weight of the chickpea protein product;

wherein the chickpea protein product is an emulsifier; and

wherein the emulsified food product is at least one of salad dressing, dip, creamer, or milk.

In embodiments, the chickpea protein product is present at 1 wt % to 10 wt %, based on the total weight of the emulsified food product.

In other embodiments, the chickpea protein product is present at 1 wt % to 7 wt %, based on the total weight of the emulsified food product.

In yet other embodiments, the chickpea protein product comprises 65 wt % to 90 wt % protein based on a total weight of the chickpea protein product.

In embodiments, the emulsified food product is free of animal products.

### BRIEF DESCRIPTION OF THE DRAWINGS

FIG. 1 is a non-limiting embodiment of a method of making the present invention; and

FIG. 2 is a non-limiting embodiment of a method of making the present invention.

The figures constitute a part of this specification and include illustrative embodiments of the present invention and illustrate various objects and features thereof. Further, the figures are not necessarily to scale, some features may be exaggerated to show details of particular components. In addition, any measurements, specifications and the like shown in the figures are intended to be illustrative, and not restrictive. Therefore, specific structural and functional details disclosed herein are not to be interpreted as limiting, but merely as a representative basis for teaching one skilled in the art to variously employ the present invention.

The present invention will be further explained with reference to the attached drawings, wherein like structures are referred to by like numerals throughout the several views. The drawings shown are not necessarily to scale, with emphasis instead generally being placed upon illustrating the principles of the present invention. Further, some features may be exaggerated to show details of particular components.

### DETAILED DESCRIPTION OF THE INVENTION

The following embodiments and aspects thereof are described and illustrated in conjunction with systems, tools and methods which are meant to be exemplary and illustrative, not limiting in scope.

Among those benefits and improvements that have been disclosed, other objects and advantages of this invention will become apparent from the following description taken in conjunction with the accompanying figures. Detailed embodiments of the present invention are disclosed herein; however, it is to be understood that the disclosed embodiments are merely illustrative of the invention that may be embodied in various forms. In addition, each of the examples given in connection with the various embodiments of the invention which are intended to be illustrative, and not restrictive.

Throughout the description, the following terms take the meanings explicitly associated herein, unless the context clearly dictates otherwise. The phrases “in one embodiment” and “in some embodiments” as used herein do not necessarily refer to the same embodiment(s), though it may. Furthermore, the phrases “in another embodiment” and “in some other embodiments” as used herein do not necessarily refer to a different embodiment, although it may. Thus, as described below, various embodiments of the invention may be readily combined, without departing from the scope or spirit of the invention.

In addition, as used herein, the term “or” is an inclusive “or” operator, and is equivalent to the term “and/or,” unless the context clearly dictates otherwise. The term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

As used herein, the phrase “chickpea protein product” means a product formed from chickpeas having at least 50 weight percent protein. The phrase “chickpea protein product” includes chickpea protein concentrates having a 50 weight percent to 90 weight percent protein and chickpea protein isolates having greater than 90 weight percent protein.

As used herein, the term “oil” refers to a triglyceride that is liquid at room temperature. The oils may be saturated or unsaturated. Non-limiting examples of oils include olive oil, coconut oil, corn oil, cottonseed oil, olive oil, palm oil, peanut oil, rapeseed oil, safflower oil, sesame oil, soybean oil, and sunflower oil.

As used herein, the term “fat” refers to a triglyceride that is solid at room temperature. The fats may be saturated or unsaturated.

As used herein, the phrase “free of animal products” is used interchangeable with the term “vegan” and may be used to describe emulsified food products according to embodiments of the present invention such as “vegan mayonnaise” or “vegan ice cream.”

In embodiments, the chickpea protein product of the present invention is a vegan, gluten-free ingredient with functional properties such as, but not limited to: (1) a product with increased viscosity, and (2) a foaming characteristic. Regarding (1) emulsification, in embodiments, the chickpea protein product allows for the production of egg-less products, while maintaining a desired creamy texture. Regarding (2) foam, in embodiments, the chickpea protein product can be used to form a foam for use in generating airy gluten-free baked-goods.

Surprisingly, the chickpea protein product according to some embodiments of the present invention enables formulation of food products enriched with protein without the need of starch or other stabilizers. This attributes contributes greatly to the ‘clean label’ agenda many producers and consumers seek.

The chickpea protein product according to some embodiments of the present invention can be used as a substitute for, e.g., but not limited to, whey protein, eggs, gluten, etc., including: dairy (e.g., but not limited to, milk, non-dairy dessert, beverages, ice-cream, or any combination thereof), spreads and dressings (e.g., but not limited to, mayonnaise, sauces, or any combination thereof), baked goods (e.g., but not limited to, gluten free bread, crackers, or any combination thereof), pasta (e.g., but not limited to, gluten-free pasta), beverages (e.g., but not limited to, sports shakes, fruit smoothies, or any combination thereof), snacks (e.g., but not limited to, energy bars), or any combination thereof.

Non-Limiting Method of Making the Chickpea Protein Product

In some embodiments, the present invention is a method for extracting protein from chickpea flour, wherein the method does not comprise use of enzymes. In some embodiments, the method comprises:
mixing chickpea flour with water at a temperature of 40 to 60° C. for 10 to 60 minutes to result in a heated chickpea mixture,
adding an alkaline agent having a pH of above 7.5 to the heated chickpea mixture to result in a basic chickpea mixture,
separating a portion of insoluble starch from the basic chickpea mixture to result in a processed chickpea mixture,
optionally, adding water to the chickpea mixture to form an aqueous chickpea mixture and centrifuging the aqueous chickpea mixture to form the processed chickpea mixture,
adjusting the pH of the processed chickpea mixture to a pH of 3.5 to 5.5 to result in an acidic chickpea mixture,
centrifuging the acidic chickpea mixture so as to result in a whey product and a protein product,
neutralizing the pH of the protein product,
drying the protein product to obtain a moisture content of 2 to 7% to result in the chickpea protein product according to some embodiments of the present invention.

In some embodiments, the water is 40 to 50° C. In some embodiments, the water is 50 to 60° C. In some embodiments, the water is 45 to 55° C.

In some embodiments, the mixing is from 10 to 50 minutes. In some embodiments, the mixing is from 10 to 40 minutes. In some embodiments, the mixing is from 10 to 30 minutes. In some embodiments, the mixing is from 10 to 20 minutes. In some embodiments, the mixing is from 20 to 60 minutes. In some embodiments, the mixing is from 30 to 60 minutes. In some embodiments, the mixing is from 40 to 60 minutes. In some embodiments, the mixing is from 50 to 60 minutes. In some embodiments, the mixing is from 20 to 50 minutes.

In some embodiments, the alkaline agent is at least one of KOH, NaOH, CaOH, NH₄OH, or NaHCO₃.

In embodiments, the acid is at least one of HCl, H2SO4, or HNO3.

In some embodiments, the solid content is 5% to 10%. In some embodiments, the solid content is 10% to 15%. In some embodiments, the solid content is 15% to 20%.

In some embodiments, the present invention is a method for preparing a chickpea protein product, wherein the chickpea protein product is derived from whole chickpeas.

In some embodiments, the present invention is a method for preparing a chickpea protein product comprising:
soaking whole chickpeas in water for up to 24 hours,
wet milling the whole chickpeas to produce a chickpea flour,
mixing the chickpea flour with water at 40 to 60° C. to produce a heated chickpea mixture, up to 6 hours.
adding an alkaline agent having a pH of above 7.5 to the heated chickpea mixture to result in a basic chickpea mixture,
separating a portion of insoluble starch from the basic chickpea mixture to result in a processed chickpea protein enriched mixture,
adjusting the pH of the processed chickpea mixture to a pH of 3.5 to 5.5 to result in an acidic chickpea mixture,
centrifuging the acidic chickpea mixture so as to result in a whey product and a protein product,
adjusting the pH of the protein product to 6.5 to 7.5,
drying the protein product.

In other embodiments, steps of the soaking whole chickpeas in water for up to 24 hours and the wet milling the whole chickpeas to produce a chickpea flour are replaced by the step of obtaining dehulled or non dehulled chickpea flour. In embodiments, 95% or more of the dehulled or the non-dehulled chickpea flour has a particle size of 200 microns or less. In embodiments, 95% or more of the dehulled or the non-dehulled chickpea flour has a particle size of 400 microns or less. In embodiments, 95% or more of the dehulled or the non-dehulled chickpea flour has a particle size of 800 microns or less. In embodiments, 95% or more of the dehulled or the non-dehulled chickpea flour has a particle size of 1000 microns or less. In embodiments, the drying the protein product is conducted to achieve a moisture content of 1% to 15%.

In some embodiments, the wet milling is performed using a colloid mill.

In some embodiments, the method comprises at least two pH extraction steps. In some embodiments, the method comprises three pH extraction steps. In some embodiments, the method comprises four pH extraction steps.

In some embodiments, the method comprises at least two pH precipitation steps. In some embodiments, the method comprises three pH precipitation steps. In some embodiments, the method comprises four pH precipitation steps.

In some embodiments, the pH precipitation steps are conducted at pH between 4.0 to 5.0. In some embodiments, the pH precipitation steps are conducted at pH of 5.0, 4.5, 4.0, or any combination thereof.

In some embodiments, the present invention is a method for preparing a chickpea protein product, comprising wet protein extraction.

In some embodiments, the method comprises incubating the chickpea flour with a lipase prior to adding the alkaline agent.

In some embodiments, the method comprises mechanically treating the whole chickpeas so as to remove the skins from the whole chickpeas. In some embodiments, the skins are removed from the whole chickpeas prior to soaking in water for up to 24 hours. In some embodiments, the skins are removed from the whole chickpeas prior to wet milling.

In some embodiments, the present invention is a chickpea protein product comprising at least 45 wt % protein. In some embodiments, the present invention is a chickpea protein product comprising at least 50 wt % protein. In some embodiments, the present invention is a chickpea protein product comprising at least 60 wt % protein.

In some embodiments, the chickpea protein product has a relative net protein of 60 wt % to 85 wt %.

In some embodiments, the chickpea protein product has an adjusted protein efficiency ratio of 1.6 to 2.4.

In some embodiments, the chickpea protein product has a protein digestibility-corrected amino acid score of at least 0.7. In some embodiments, the chickpea protein product has a protein digestibility-corrected amino acid score of at least 0.8. In some embodiments, the chickpea protein product has a protein digestibility-corrected amino acid score of at least 0.9. In some embodiments, the chickpea protein product has a protein digestibility-corrected amino acid score of 0.7 to 0.9.

In some embodiments, the chickpea protein product has an increased calculated protein digestability compared to raw chickpea.

In some embodiments, the chickpea protein product has a shelf life of at least 12 months. In some embodiments, the chickpea protein product has a shelf life of 12 to 36 months. In some embodiments, the chickpea protein product has a shelf life of 12 to 24 months. In some embodiments, the chickpea protein product has a shelf life of 24 to 36 months. In some embodiments, the chickpea protein product has a shelf life of 18 to 30 months, under suitable storage conditions

In some embodiments, the chickpea protein product does not include an emulsifier.

In some embodiments, the chickpea protein product may be soluble in an aqueous solution.

In some embodiments, the present invention is a method for making an emulsion, comprising:
mixing sugar, the chickpea protein product according to some embodiments of the present invention, and salt to result in a dry mixture,
adding water to the dry mixture to result in an aqueous mixture,
stirring the aqueous mixture,
adding oil to the aqueous mixture while stirring to result in a solution,
adding vinegar and lemon concentrate to the solution to result in the emulsion,
   wherein the oil is 60 to 80 wt % of the emulsion,
   wherein the water is 10 to 30 wt % of the emulsion,
   wherein vinegar is 2 to 6 wt % of the emulsion,
   wherein sugar is 2 to 4 wt % of the emulsion,
   wherein the chickpea protein product according to some embodiments of the present invention is 1 to 12 wt % of the emulsion,
   wherein the salt is 0.1 to 2 wt % of the emulsion,
   wherein the lemon concentrate is 0.01 to 0.5 wt % of the emulsion.

In some embodiments, the emulsion has a droplet size of 0.1 to 1 micron.

In some embodiments, the emulsion has a zeta potential of +30 mV to +60 mV.

In some embodiments, the present invention is a method for making gluten-free dough using the chickpea protein product according to some embodiments of the present invention. In some embodiments, the gluten-free dough is suitable for making pizza, pasta, bakery products, or any combination thereof.

In some embodiments, the present invention is a method for making egg-like vegan products using the chickpea protein product according to some embodiments of the present invention.

In some embodiments, the present invention is a method for making nutritional bars, ice cream, non-dairy beverages, drinks, or any food product using the chickpea protein product according to some embodiments of the present invention.

In some embodiments, the present invention is a method for making sport nutrition products, bars or high-protein-concentration drinks using a chickpea protein product according to some embodiments of the present invention, wherein the chickpea protein product comprises at least 50% protein.

In some embodiments, the present invention is a method for making gluten-free pasta and baked goods, nutritional bars, ice cream, dairy alternatives, drinks and other food products using the a chickpea protein product according to some embodiments of the present invention.

In some embodiments, the present invention is a method for extracting protein from chickpea flour, wherein the method does not include the use of enzymes. In some embodiments, the method comprises:
mixing chickpea flour with water at a temperature of 40 to 60° C. for 10 to 60 minutes to result in a heated chickpea mixture,
adding an alkaline agent to the heated chickpea mixture to result in a basic chickpea mixture,
separating a portion of insoluble starch from the basic chickpea mixture to result in a processed chickpea mixture,
adjusting the pH of the processed chickpea mixture to a pH of 4 to 6.6 to result in an acidic chickpea mixture,
centrifuging the acidic chickpea mixture so as to result in a whey product and a protein product,
neutralizing the pH of the protein product,
drying the protein product to obtain a solid content of 1 to 20% to result in a chickpea protein product according to some embodiments of the present invention.

In some embodiments, the water temperature is 40 to 50° C. In some embodiments, the water temperature is 50 to 60° C. In some embodiments, the water temperature is 45 to 55° C.

In some embodiments, the mixing is from 10 to 50 minutes. In some embodiments, the mixing is from 10 to 40 minutes. In some embodiments, the mixing is from 10 to 30 minutes. In some embodiments, the mixing is from 10 to 20 minutes. In some embodiments, the mixing is from 20 to 60 minutes. In some embodiments, the mixing is from 30 to 60 minutes. In some embodiments, the mixing is from 40 to 60 minutes. In some embodiments, the mixing is from 50 to 60 minutes. In some embodiments, the mixing is from 20 to 50 minutes.

In some embodiments, the alkaline agent is KOH NaOH, CaOH, NH₄OH, NaHCO₃, or a combination thereof.

In some embodiments the neutralized slurry is agitated using a homogenizer. In embodiments, the homogenized slurry is cooled after heating. In some embodiments, the cooling is conducted using a jacketed chilling tank.

In embodiments, the product is subjected to spray drying to a solids content of 5% to 20%. In embodiments, the spray dryer is a tall form high pressure nozzles spray dryer. In embodiments, the spray dryer is operated for a sufficient time to reduce the solids content to the target weight percent.

In some embodiments, the solid content of the chickpea protein product is 5% to 20%. In some embodiments, the solid content is 5% to 15%. In some embodiments, the solid content is 5% to 10%. In some embodiments, the solid content is 10% to 20%. In some embodiments, the solid content is 15% to 20%. In some embodiments, the solid content is 10% to 15%.

In some embodiments, the present invention is a method for preparing a chickpea protein product, wherein a chickpea protein product is derived from whole chickpeas.

In other embodiments, the chickpea protein product is derived from dehulled or non dehulled chickpea flour.

In some embodiments, the present invention is a method for preparing a chickpea protein product comprising:
soaking whole chickpeas in water for up to 24 hours,
wet milling the whole chickpeas to produce a chickpea flour,
mixing the chickpea flour with water at 40 to 60° C. to produce a heated chickpea mixture, adding an alkaline agent having a pH of above 7 to the heated chickpea mixture to result in a basic chickpea mixture,
separating a portion of insoluble starch from the basic chickpea mixture to result in a processed chickpea mixture,
adjusting the pH of the processed chickpea mixture to a pH of 3.5 to 5.5 to result in an acidic chickpea mixture,
centrifuging the acidic chickpea mixture so as to result in a whey product and a protein product,
adjusting the pH of the processed chickpea mixture to a pH of 3.5 to 5.5,
optionally, centrifuging the acidic chickpea mixture so as to result in a whey product and a protein product,
adjusting the pH of the chickpea protein product to 6.5 to 7.5.

In embodiments, the method further includes drying the chickpea protein product to obtain a moisture content of 1% to 15%.

In embodiments, the drying step may be conducted by spray drying the chickpea protein product.

In yet other embodiments, the method may further include cooling the dried chickpea protein product.

In some embodiments, the wet milling is performed using a colloid mill.

In some embodiments, the method comprises at least two pH precipitation steps. In some embodiments, the method comprises three pH precipitation steps.

In some embodiments, the pH precipitation steps are conducted at pH of 3.5 to 5.5. In some embodiments, the pH precipitation steps are conducted at pH of 5, 4.5, 4, or any combination thereof.

In some embodiments, the present invention is a method for preparing a chickpea protein product, comprising wet protein extraction.

In some embodiments, the method comprises incubating the chickpea flour with a lipase prior to adding the alkaline agent.

In some embodiments, the method comprises mechanically treating the whole chickpeas so as to remove the skins from the whole chickpeas. In some embodiments, the skins are removed from the whole chickpeas prior to soaking in water for 12 to 24 hours. In some embodiments, the skins are removed from the whole chickpeas prior to wet milling.

In some embodiments, the method further includes grinding the chickpeas to form a flour. In embodiments, the chickpeas may be dehulled or non-dehulled.

Chickpea Protein Product

In some embodiments, the present invention is a chickpea protein product comprising at least 50 wt % protein. In some embodiments, the present invention is a chickpea protein product comprising at least 60 wt % protein.

In some embodiments, the chickpea protein product has 50 wt % to 99 wt % protein. In some embodiments, the chickpea protein product has 55 wt % to 99 wt % protein. In some embodiments, the chickpea protein product has 60 wt % to 99 wt % protein. In some embodiments, the chickpea protein product has 65 wt % to 99 wt % protein. In some embodiments, the chickpea protein product has 70 wt % to 99 wt % protein. In some embodiments, the chickpea protein product has 75 wt % to 99 wt % protein. In some embodiments, the chickpea protein product has 80 wt % to 99 wt % protein. In some embodiments, the chickpea protein product has 85 wt % to 99 wt % protein. In some embodiments, the chickpea protein product has 90 wt % to 99 wt % protein. In some embodiments, the chickpea protein product has 95 wt % to 99 wt % protein. In some embodiments, the chickpea protein product has 97 wt % to 99 wt % protein.

In some embodiments, the chickpea protein product has 50 wt % to 97 wt % protein. In some embodiments, the chickpea protein product has 50 wt % to 95 wt % protein. In some embodiments, the chickpea protein product has 50 wt % to 90 wt % protein. In some embodiments, the chickpea protein product has 50 wt % to 85 wt % protein. In some embodiments, the chickpea protein product has 50 wt % to 80 wt % protein. In some embodiments, the chickpea protein product has 50 wt % to 75 wt % protein. In some embodiments, the chickpea protein product has 50 wt % to 70 wt % protein. In some embodiments, the chickpea protein product has 50 wt % to 65 wt % protein. In some embodiments, the chickpea protein product has 50 wt % to 60 wt % protein. In some embodiments, the chickpea protein product has 50 wt % to 55 wt % protein. In some embodiments, the chickpea protein product has 50 wt % protein.

In some embodiments, the chickpea protein product has 50 wt % to 97 wt % protein. In some embodiments, the chickpea protein product has 55 wt % to 95 wt % protein. In some embodiments, the chickpea protein product has 60 wt % to 90 wt % protein. In some embodiments, the chickpea protein product has 65 wt % to 85 wt % protein. In some embodiments, the chickpea protein product has 70 wt % to 80 wt % protein.

In some embodiments, the chickpea protein product has an adjusted protein efficiency ratio of 1.6 to 2.4. In some embodiments, the chickpea protein product has a protein digestibility-corrected amino acid score of at least 0.7. In some embodiments, the chickpea protein product has a protein digestibility-corrected amino acid score of at least 0.8. In some embodiments, the chickpea protein product has a protein digestibility-corrected amino acid score of at least 0.9.

In some embodiments, the chickpea protein product has an increased apparent protein digestability compared to raw chickpea.

In some embodiments, the chickpea protein product has a shelf life of at least 12 months. In some embodiments, the chickpea protein product has a shelf life of 12 to 36 months. In some embodiments, the chickpea protein product has a shelf life of 12 to 24 months. In some embodiments, the chickpea protein product has a shelf life of 24 to 36 months. In some embodiments, the chickpea protein product has a shelf life of 18 to 36 months.

In some embodiments, the chickpea protein product does not include an emulsifier.

In some embodiments, the chickpea protein product is soluble in an aqueous solution.

Food Products Containing the Chickpea Protein Product

In embodiments, the present invention is a food product having the chickpea protein product detailed herein. Unless otherwise specified, the term “wt %” corresponds to weight percent based on a total weight of corresponding food product.

In embodiments, the present invention is a mayonnaise emulsified food product consisting essentially of:

In embodiments, the mayonnaise emulsified food product includes 60 wt % to 80 wt % of oil. In yet other embodiments, the mayonnaise emulsified food product includes 65 wt % to 80 wt % of oil. In yet other embodiments, the mayonnaise emulsified food product includes 70 wt % to 80 wt % of oil. In yet other embodiments, the mayonnaise emulsified food product includes 75 wt % to 80 wt % of oil. In yet other embodiments, the mayonnaise emulsified food product includes 60 wt % to 75 wt % of oil. In yet other embodiments, the mayonnaise emulsified food product includes 65 wt % to 70 wt % of oil. In yet other embodiments, the mayonnaise emulsified food product includes 60 wt % to 65 wt % of oil. In yet other embodiments, the mayonnaise emulsified food product includes 65 wt % to 75 wt % of oil. In yet other embodiments, the mayonnaise emulsified food product includes 65 wt % of oil. In yet other embodiments, the mayonnaise emulsified food product includes 70 wt % of oil

In embodiments, the mayonnaise emulsified food product includes 10 wt % to 30 wt % of water. In embodiments, the mayonnaise emulsified food product includes 15 wt % to 30 wt % of water. In embodiments, the mayonnaise emulsified food product includes 20 wt % to 30 wt % of water. In embodiments, the mayonnaise emulsified food product includes 25 wt % to 30 wt % of water. In embodiments, the mayonnaise emulsified food product includes 10 wt % to 25 wt % of water. In embodiments, the mayonnaise emulsified food product includes 10 wt % to 20 wt % of water. In embodiments, the mayonnaise emulsified food product includes 10 wt % to 15 wt % of water. In embodiments, the mayonnaise emulsified food product includes 15 wt % to 25 wt % of water. In embodiments, the mayonnaise emulsified food product includes 10 wt %. In embodiments, the mayonnaise emulsified food product includes 20 wt % of water.

In embodiments, the mayonnaise emulsified food product includes 1 wt % to 5 wt % of chickpea protein product. In embodiments, the mayonnaise emulsified food product includes 1 wt % to 5 wt % of chickpea protein product. In embodiments, the mayonnaise emulsified food product includes 2 wt % to 5 wt % of chickpea protein product. In embodiments, the mayonnaise emulsified food product includes 3 wt % to 5 wt % of chickpea protein product. In embodiments, the mayonnaise emulsified food product includes 4 wt % to 5 wt % of chickpea protein product. In embodiments, the mayonnaise emulsified food product includes 1 wt % to 4 wt % of chickpea protein product. In embodiments, the mayonnaise emulsified food product includes 1 wt % to 3 wt % of chickpea protein product. In embodiments, the mayonnaise emulsified food product includes 1 wt % to 2 wt % of chickpea protein product. In embodiments, the mayonnaise emulsified food product includes 1 wt % of chickpea protein product. In embodiments, the mayonnaise emulsified food product includes 2 wt % of chickpea protein product. In embodiments, the mayonnaise emulsified food product includes 3 wt % of chickpea protein product. In embodiments, the mayonnaise emulsified food product includes 4 wt % of chickpea protein product. In embodiments, the mayonnaise emulsified food product includes 5 wt % of chickpea protein product.

In embodiments, the mayonnaise emulsified food product includes at least one of vinegar, salt, lemon concentrate, or sugar.

In yet other embodiments, the mayonnaise emulsified food product includes 2 wt % to 10 wt % of vinegar. In yet other embodiments, the mayonnaise emulsified food product includes 4 wt % to 10 wt % of vinegar. In yet other embodiments, the mayonnaise emulsified food product includes 8 wt % to 10 wt % of vinegar. In yet other embodiments, the mayonnaise emulsified food product includes 2 wt % to 8 wt % of vinegar. In yet other embodiments, the mayonnaise emulsified food product includes 2 wt % to 4 wt % of vinegar. In yet other embodiments, the mayonnaise emulsified food product includes 2 wt % of vinegar. In yet other embodiments, the mayonnaise emulsified food product includes 4 wt % of vinegar. In yet other embodiments, the mayonnaise emulsified food product includes 10 wt % of vinegar.

In yet another embodiment, the mayonnaise emulsified food product includes 2 wt % to 8 wt % of sugar. In yet another embodiment, the mayonnaise emulsified food product includes 4 wt % to 8 wt % of sugar. In yet another embodiment, the mayonnaise emulsified food product includes 6 wt % to 8 wt % of sugar. In yet another embodiment, the mayonnaise emulsified food product includes 2 wt % to 6 wt % of sugar. In yet another embodiment, the mayonnaise emulsified food product includes 2 wt % to 4 wt % of sugar. In yet another embodiment, the mayonnaise emulsified food product includes 4 wt % to 6 wt % of sugar. In yet another embodiment, the mayonnaise emulsified food product includes 2 wt % of sugar. In yet another embodiment, the mayonnaise emulsified food product includes 4 wt % of sugar. In yet another embodiment, the mayonnaise emulsified food product includes 6 wt % of sugar. In yet another embodiment, the mayonnaise emulsified food product includes 8 wt % of sugar.

In embodiments, the mayonnaise emulsified food product is free of animal products.

In another embodiment, the present invention is an ice cream emulsified food product.

In embodiments, the ice cream emulsified food product includes 4 wt % to 30 wt % fat. In embodiments, the ice cream emulsified food product includes 8 wt % to 30 wt % fat. In embodiments, the ice cream emulsified food product includes 12 wt % to 30 wt % fat. In embodiments, the ice cream emulsified food product includes 16 wt % to 30 wt % fat. In embodiments, the ice cream emulsified food product includes 20 wt % to 30 wt % fat. In embodiments, the ice cream emulsified food product includes 25 wt % to 30 wt % fat. In embodiments, the ice cream emulsified food product includes 4 wt % to 25 wt % fat. In embodiments, the ice cream emulsified food product includes 4 wt % to 20 wt % fat. In embodiments, the ice cream emulsified food product includes 4 wt % to 16 wt % fat. In embodiments, the ice cream emulsified food product includes 4 wt % to 12 wt % fat. In embodiments, the ice cream emulsified food product includes 4 wt % to 8 wt % fat. In embodiments, the ice cream emulsified food product includes 4 wt % fat. In embodiments, the ice cream emulsified food product includes 12 wt % fat. In embodiments, the ice cream emulsified food product includes 20 wt % fat. In embodiments, the ice cream emulsified food product includes 25 wt % fat.

In embodiments, the ice cream emulsified food product includes 35 wt % to 80 wt % water. In embodiments, the ice cream emulsified food product includes 45 wt % to 80 wt % water. In embodiments, the ice cream emulsified food product includes 55 wt % to 80 wt % water. In embodiments, the ice cream emulsified food product includes 65 wt % to 80 wt % water. In embodiments, the ice cream emulsified food product includes 75 wt % to 80 wt % water. In embodiments, the ice cream emulsified food product includes 35 wt % to 75 wt % water. In embodiments, the ice cream emulsified food product includes 35 wt % to 65 wt % water. In embodiments, the ice cream emulsified food product includes 35 wt % to 55 wt % water. In embodiments, the ice cream emulsified food product includes 35 wt % to 45 wt % water. In embodiments, the ice cream emulsified food product includes 45 wt % to 60 wt % water. In embodiments, the ice cream emulsified food product includes 50 wt % to 75 wt % water. In embodiments, the ice cream emulsified food product includes 55 wt % to 65 wt % water.

In embodiments, the ice cream emulsified food product includes 35 wt % water. In embodiments, the ice cream emulsified food product includes 45 wt % water. In embodiments, the ice cream emulsified food product includes 55 wt % water. In embodiments, the ice cream emulsified food product includes 65 wt % water. In embodiments, the ice cream emulsified food product includes 75 wt % water. In embodiments, the ice cream emulsified food product includes 80 wt % water.

In embodiments, the ice cream emulsified food product includes 0.05 wt % to 10 wt % chickpea protein product. In embodiments, the ice cream emulsified food product includes 1 wt % to 10 wt % chickpea protein product. In embodiments, the ice cream emulsified food product includes 2 wt % to 10 wt % chickpea protein product. In embodiments, the ice cream emulsified food product includes 3 wt % to 10 wt % chickpea protein product. In embodiments, the ice cream emulsified food product includes 4 wt % to 10 wt % chickpea protein product. In embodiments, the ice cream emulsified food product includes 5 wt % to 10 wt % chickpea protein product. In embodiments, the ice cream emulsified food product includes 6 wt % to 10 wt % chickpea protein product. In embodiments, the ice cream emulsified food product includes 7 wt % to 10 wt % chickpea protein product. In embodiments, the ice cream emulsified food product includes 8 wt % to 10 wt % chickpea protein product. In embodiments, the ice cream emulsified food product includes 9 wt % to 10 wt % chickpea protein product.

In embodiments, the ice cream emulsified food product includes 0.05 wt % to 9 wt % chickpea protein product. In embodiments, the ice cream emulsified food product includes 0.05 wt % to 8 wt % chickpea protein product. In embodiments, the ice cream emulsified food product includes 0.05 wt % to 7 wt % chickpea protein product. In embodiments, the ice cream emulsified food product includes 0.05 wt % to 6 wt % chickpea protein product. In embodiments, the ice cream emulsified food product includes 0.05 wt % to 5 wt % chickpea protein product. In embodiments, the ice cream emulsified food product includes 0.05 wt % to 4 wt % chickpea protein product. In embodiments, the ice cream emulsified food product includes 0.05 wt % to 3 wt % chickpea protein product. In embodiments, the ice cream emulsified food product includes 0.05 wt % to 2 wt % chickpea protein product. In embodiments, the ice cream emulsified food product includes 0.05 wt % to 1 wt % chickpea protein product.

In embodiments, the ice cream emulsified food product includes 1 wt % chickpea protein product. In embodiments, the ice cream emulsified food product includes 2 wt % chickpea protein product. In embodiments, the ice cream emulsified food product includes 3 wt % chickpea protein product. In embodiments, the ice cream emulsified food product includes 4 wt % chickpea protein product. In embodiments, the ice cream emulsified food product includes 5 wt % chickpea protein product. In embodiments, the ice cream emulsified food product includes 6 wt % chickpea protein product. In embodiments, the ice cream emulsified food product includes 7 wt % chickpea protein product. In embodiments, the ice cream emulsified food product includes 8 wt % chickpea protein product. In embodiments, the ice cream emulsified food product includes 9 wt % chickpea protein product. In embodiments, the ice cream emulsified food product includes 10 wt % chickpea protein product.

In embodiments, the ice cream emulsified food product includes at least one of sugar, honey or syrup.

In an embodiment, the present invention is an emulsified food product. In embodiments, the emulsified food product is any of the emulsified food products detailed herein including, but not limited to, mayonnaise, ice cream, creamer, salad dressing.

In embodiments, the emulsified food product includes water and at least one of oil or fat in any of the weight percent ranges detailed herein.

In embodiments, the emulsified food product includes 1 wt % to 12 wt % chickpea protein product. In embodiments, the emulsified food product includes 2 wt % to 12 wt % chickpea protein product. In embodiments, the emulsified food product includes 3 wt % to 12 wt % chickpea protein product. In embodiments, the emulsified food product includes 4 wt % to 12 wt % chickpea protein product. In embodiments, the emulsified food product includes 5 wt % to 12 wt % chickpea protein product. In embodiments, the emulsified food product includes 6 wt % to 12 wt % chickpea protein product. In embodiments, the emulsified food product includes 7 wt % to 12 wt % chickpea protein product. In embodiments, the emulsified food product includes 8 wt % to 12 wt % chickpea protein product. In embodiments, the emulsified food product includes 9 wt % to 12 wt % chickpea protein product. In embodiments, the emulsified food product includes 10 wt % to 12 wt % chickpea protein product. In embodiments, the emulsified food product includes 11 wt % to 12 wt % chickpea protein product.

In embodiments, the emulsified food product includes 1 wt % to 11 wt % chickpea protein product. In embodiments, the emulsified food product includes 1 wt % to 10 wt % chickpea protein product. In embodiments, the emulsified food product includes 1 wt % to 9 wt % chickpea protein product. In embodiments, the emulsified food product includes 1 wt % to 8 wt % chickpea protein product. In embodiments, the emulsified food product includes 1 wt % to 7 wt % chickpea protein product. In embodiments, the emulsified food product includes 1 wt % to 6 wt % chickpea protein product. In embodiments, the emulsified food product includes 1 wt % to 5 wt % chickpea protein product. In embodiments, the emulsified food product includes 1 wt % to 4 wt % chickpea protein product. In embodiments, the emulsified food product includes 1 wt % to 3 wt % chickpea protein product. In embodiments, the emulsified food product includes 1 wt % to 2 wt % chickpea protein product. In embodiments, the emulsified food product includes 3 wt % to 7 wt % chickpea protein product. In embodiments, the emulsified food product includes 5 wt % to 9 wt % chickpea protein product.

In embodiments, the emulsified food product is at least one of salad dressing, dip, creamer, or milk.

In embodiments, the chickpea protein product is present at 1 wt % to 10 wt %, based on the total weight of the emulsified food product.

Additional non-limiting examples of food products according to embodiments of the present invention are included below.

In embodiments, mayonnaise and mayonnaise like emulsified food products may include 60 wt % to 80 wt % of oil, based on a total weight of the mayonnaise emulsified food product, 10 wt % to 30 wt % of water, based on the total weight of the mayonnaise emulsified food product, 1 wt % to 5 wt % of the chickpea protein product, based on the total weight of the mayonnaise emulsified food product, and optionally at least one of vinegar, salt, lemon concentrate, sugar, aioli, tartar, capers, gherkins, dill, remoulade, horseradish, paprika, or anchovies.

In embodiments, the mayonnaise and mayonnaise like emulsified food products are made by combining water, vinegar, mustard, salt, sugar, chickpea protein product, and other ingredients except oil and mixing sufficiently such that all salt and sugar are dissolved. The oil is then added at a sufficient speed such that the rate of emulsification is equal or higher than the rate of oil addition to form the food product.

In embodiments, vinaigrette-type salad dressing emulsified food products may include 10 wt % to 40 wt % of oil, based on a total weight of the vinaigrette-type salad dressing emulsified food product, 50 wt % to 85 wt % of water, based on the total weight of the vinaigrette-type salad dressing emulsified food product, 0.05 wt % to 4 wt % of the chickpea protein product, based on the total weight of the vinaigrette-type salad dressing emulsified food product, and optionally at least one of vinegar, lemon, sugar, salt, mustard, fine herbs, fruits, or condiments.

In embodiments, vinaigrette-type salad dressing emulsified food products are made by combining water, vinegar, mustard, salt, sugar, chickpea protein product, and other ingredients except oil and mixing sufficiently such that all salt and sugar are dissolved. The oil is then added at a sufficient speed such that the rate of emulsification is equal or higher than the rate of oil addition to form the food product.

In embodiments, creamy salad dressing emulsified food products such as French, Creamy Italian or Ranch salad dressing may include 10 wt % to 40 wt % of oil, based on a total weight of the creamy salad dressing emulsified food product, 50 wt % to 85 wt % of water, based on the total weight of the creamy salad dressing emulsified food product, and 0.05 wt % to 4 wt % of the chickpea protein product, based on a total weight of the creamy salad dressing emulsified food product.

In embodiments, the French creamy salad dressing emulsified food product may optionally further include at least one of olive oil, vinegar, tomato paste, ketchup, brown sugar, paprika, and salt.

In embodiments, the Italian creamy salad dressing emulsified food product may optionally further include at least one of vinegar, lemon juice, chopped bell peppers, sugar, corn syrup, oregano, fennel, dill or salt.

In embodiments, the Ranch creamy salad dressing emulsified food product may optionally further include at least one of buttermilk, salt, garlic, onion, mustard, chives, parsley, dill, black pepper, paprika, or ground mustard seed.

In embodiments, creamy salad dressing emulsified food products are made by making the mayonnaise and mayonnaise like emulsified food products as detailed herein. Then, mixing the mayonnaise and mayonnaise like emulsified food products with the ingredients detailed above such as ketchup, onion, and garlic to form a smooth creamy emulsified food product.

In embodiments, dip emulsified food products may include 20 wt % to 85 wt % of oil, based on a total weight of the dip emulsified food product, 10 wt % to 85 wt % of water, based on the total weight of the dip emulsified food product, and 0.05 wt % to 4 wt % of the chickpea protein product, based on the total weight of the dip emulsified food product and optionally at least one of fine herbs, sweet potatoes, roasted bell peppers, eggplant, or cauliflower.

In embodiments, dip emulsified food products are made by are made by making the mayonnaise and mayonnaise like emulsified food products as detailed herein. Then, mixing the mayonnaise and mayonnaise like emulsified food products with the ingredients detailed above such as lemon juice, condiments, buttermilk, ketchup, onion, garlic, roasted peppers, roasted eggplant to form a semi-solid dip emulsified food product.

In embodiment, ice cream and vegan ice cream emulsified food products may include 4 wt % to 30 wt % of fat, based on a total weight of the ice cream emulsified food product, 35 wt % to 80 wt % of water, based on the total weight of the ice cream emulsified food product, and 1 wt % to 5 wt % of the chickpea protein product, based on the total weight of the ice cream emulsified food product and optionally at least one of vanilla extract, sugar, honey, syrup, or milk.

In a non-limiting example, the ice cream emulsified food product may be produced using a mixture of 5% to 8% chickpea protein product, 10% to 15% sugar, 2% to 15% heavy cream, 0.001 to 0.1% vanilla extract and whole milk. In the non-limiting example, the mixture may be heated to a temperature of 65 degrees Celsius to 98 degrees Celsius or to boiling, homogenized using a high shear mixer or a piston homogenizer with homogenization pressure of 50 bar to 200 bar. After the homogenization the mixture may be refrigerated for 10 to 20 hours to form the ice cream emulsified food product.

In a non-limiting example, to produce vegan ice cream the chickpea protein serves both as an emulsifier, replacing the egg yolk and as a source for protein, replacing casein obtained from dairy products. In such recipe the level of chickpea protein may be between 0.5% to 10% with the addition of 10% to 15% sugar, 0.001% to 0.1% vanilla, 2% to 20% of vegetable oil and the rest contains water. The mixture is heated to a temperature of 65 degrees Celsius to 98 degrees Celsius or to boiling, homogenized using a high shear mixer or a piston homogenizer with homogenization pressure of 50 bar to 200 bar. After the homogenization the mixture is refrigerated for 10 to 2014 hours and placed in an ice cream machine to produce vegan vanilla ice cream. This recipe can serve as base for many types of flavored ice creams.

In embodiments, vegan creamers may serve as a substitute for cream in various preparations, such as hot drinks and desserts. In embodiments, vegan creamer emulsified products may include 1 wt % to 15 wt % of oil such as vegetable oil, based on a total weight of the vegan creamer emulsified product, 15 wt % to 90 wt % of water, based on the total weight of the vegan creamer emulsified product, and 1 wt % to 10 wt % of the chickpea protein product, based on the total weight of the vegan creamer emulsified product and optionally at least one of flavoring, gellan gum, or sugar. In embodiments, the vegan cream emulsified product includes 2 wt % to 8 wt % of the chickpea protein product.

In a non-limiting example, the vegan creamer emulsified product is made by mixing the ingredients and homogenizing in a piston type homogenizer with pressure of 50 bar to 200 bar. The mixture is may then be processed under UHT conditions and filled aseptically into containers.

In embodiments, vegan milk emulsified products may include 1 wt % to 13 wt % of oil such as vegetable oil, based on a total weight of the vegan milk emulsified product, 90 wt % to 98 wt % of water, based on the total weight of the vegan milk emulsified product, and 1 wt % to 12 wt % of the chickpea protein product, based on the total weight of the vegan milk emulsified product and optionally at least one of flavoring, gellan gum, or salt.

In a non-limiting example, the vegan milk emulsified product is made by mixing the ingredients and homogenizing in a piston type homogenizer with pressure of 50 bar to 200 bar. The mixture is may then be processed under UHT conditions and filled aseptically into containers.

In yet other embodiments, the food product containing the chickpea protein product may include, but is not limited to baked goods such as, but not limited to, sponge cakes, biscuits, pies, rolls, bagels, muffins, cookies, brownies, crackers, and custards. In embodiments, the egg yolks in the baked goods are replaced with the chickpea protein product. In embodiments, each egg yolk is replaced with 4 grams to 8 grams of chickpea protein product and 10 grams to 14 grams of water.

In an embodiment, the food product is a brownie that includes 10 grams to 50 grams of butter, 25 grams to 75 grams of coconut oil, 100 grams to 300 grams of dark chocolate, 100 grams to 300 grams of sugar, 25 grams to 75 grams of chickpea protein product, 100 grams to 300 grams of flour, a pinch of salt and vanilla extract to taste.

In a non-limiting example, the brownie food product is made by melting butter, coconut oil and chocolate, mixing the dry ingredients, and mixing the melted chocolate mixtures with the mixed dry ingredients. The resultant mixtures is then combined with ¼ cup to 1 cup of water and added to a baking pan for baking for 10 to 15 minutes at 150 to 180 degree Celsius. The cooked product is then allowed to cool at room temperature for at least 15 minutes.

In another embodiment, the food product is a fruit or nut bar food product with 1 gram to 2 grams of the chickpea protein product replacing every 1 gram of lecithin emulsifier.

In yet other embodiments, the food product is a meat or poultry food product having 0.5 wt % to 2 wt % of chickpea protein product resulting in enhanced juiciness and improved yield.

In yet other embodiments, the food product is a bread food product with each egg yolk replaced with 4 grams to 8 grams of chickpea protein product and 10 grams to 14 grams of water. In embodiments, the bread food product having 0.5 wt % to 4 wt % chickpea protein product results in improved texture and shelf life.

In embodiments, the food product is a cereal food product with 1 gram to 2 grams of chickpea protein product replacing each 1 gram of lecithin.

In yet other embodiment, the food product is a dairy-free, egg-free cooking sauce food product such as hollandaise or béarnaise with each egg yolk replaced with 4 grams to 8 grams of chickpea protein product and 10 grams to 14 grams of water.

In some embodiments, the present invention is a method for making gluten-free dough using the chickpea protein product according to some embodiments of the present invention. In some embodiments, the gluten-free dough is suitable for making pizza, pasta, bakery products, or any combination thereof.

In some embodiments, the present invention is a method for making egg-like vegan products using the chickpea protein product according to some embodiments of the present invention.

In some embodiments, the present invention is a method for making nutritional bars, ice cream, non-dairy beverages, drinks, or any food product using the chickpea protein product according to some embodiments of the present invention.

In some embodiments, the present invention is a method for making sport nutrition products, bars or high-protein-concentration drinks using the chickpea protein product according to some embodiments of the present invention, wherein the chickpea protein product comprises at least 50% chickpea protein.

In some embodiments, the present invention is a method for making gluten-free pasta and baked goods, nutritional bars, ice cream, dairy alternatives, drinks and other food products using the chickpea protein product according to some embodiments of the present invention.

The present invention is further illustrated, but not limited by, the following non-limiting examples.

### Example 1: Scaled-Up Production of Chickpea Protein Product and Chickpea Starch (CPS)

I. Chickpea Protein Product Production:

The following protocol was used to produce the Chickpea Protein Product: 2,200 pounds of chickpea flour was mixed with water (130° F.) and caustic to a pH of 8 to 9 in an agitated tank to form a slurry. The slurry was then fed into a centrifuge to separate the insoluble starch-fiber by product (solids) from the protein extract (liquid). The starch solids fraction was then re-hydrated with water, heated to about 150 degrees Fahrenheit for about 20 to 40 minutes. The starch solids fraction was then spray dried to produce the Chickpea Starch (CPS) by product. The liquid extract was precipitated by adding acid to a pH of 3.5 to 4.5 in an agitated tank at a temperature of 110 degrees Fahrenheit to 140 degrees Fahrenheit for 10 minutes to 60 minutes. The mixture was then fed continuously to a centrifuge. The sugar liquid by product (whey) was sampled and disposed to the drain. The protein curd solids were rehydrated with water and held under mild agitation before being fed to a centrifuge. The washed liquid by-product was sampled and disposed.

The second protein curd solids were modified by adjusting the solids level to 7% to 15% with some heated water at 115° F. and adjusting the pH to 6.5 to 7.0 with alkaline agent. The neutralized slurry was agitated and homogenized using a homogenizer. The homogenized slurry was then heated to 180 degrees Fahrenheit to 190 degrees Fahrenheit using a heat exchanger. The heated slurry was then cooled to about 120 degrees Fahrenheit for 10 minutes to 30 minutes. The protein was then fed to a spray dryer to produce a chickpea protein product.

2. Chemical Analysis:

Moisture/Dry Solids

Samples collected from the above processes were analyzed for moisture/dry solids level using a CEM microwave moisture analyzer.

Protein Content

The protein content was analyzed according to the Kjeldahl protein analysis (protein factor 6.25%).

(see, e.g., http://www.expotechusa.com/catalogs/labconco/pdf/KJELDAHLguide.PDF)

Fat Content

The Mojonnier, Acid Hydrolysis method was used to determine FFA content of the dry protein products and raw material. (See, e.g., Nazareth Z M, Deak N A, Johnson L A (2009) Functional properties of soy protein isolates prepared from gas-supported screw-pressed soybean meal. J Am Oil Chem Soc J Am Oil Chem Soc 86:315-321).

Chickpea Protein Product Composition:

Table 1 represents moisture and protein composition of the raw material and each product or by-product produced in the pilot Chickpea Protein Product runs.

TABLE 1

| | | % Protein |
|---|---|---|
| Product | % Moisture | (dry basis) |
| Chickpea Flour (Raw Material) | 9.2 | 24.9 |
| Chickpea Protein Product | 4.5 | 68 |
| Starch-Fiber (dry) | 5.0 | 5.0 |
| Sugar Waste | 98.5 | 25 |

Analytical Results

Part A.

Analytical results are shown in Table 2.

TABLE 2

| | | Limit of | Limit of |
|---|---|---|---|
| | Value/Uncertain | quantification | detection |
| ON SAMPLE AS IT IS | (unit of measure: g/100 g) | (LoQ) | (LoD) |
| TRYPTOPHAN 0.25 ± 0.07 g/100 g | 0.25 +/− 0.07 | 0.10 | 0.050 |
| SULPHURATED AMINO ACIDS | | | |
| Cystin | 0.534 ± 0.064 | 0.010 | |
| Methionine 0.010 | 0.720 ± 0.087 | 0.010 | |
| AMINOACIDIC COMPOSITION | | LoQ: | |
| (AFTER HYDROLYZE) | | 0.010 | |
| Aspartic acid | 7.10 ± 0.85 | | |
| Threonine | 2.06 ± 0.25 | | |
| Serine | 2.87 ± 0.35 | | |
| Glutamic acid | 10.0 ± 1.2 | | |
| Proline | 2.25 ± 0.27 | | |
| Glycine | 2.28 ± 0.28 | | |
| Alanine | 2.48 ± 0.30 | | |
| Valine | 2.94 ± 0.36 | | |
| Isoleucine | 2.75 ± 0.33 | | |
| Leucine | 4.66 ± 0.56 | | |
| Tyrosin | 1.56 ± 0.19 | | |
| Phenylalanine | 3.90 ± 0.47 | | |
| Lysine | 3.68 ± 0.44 | | |
| Hystidine | 1.57 ± 0.19 | | |
| Arginine | 6.03 ± 0.73 | | |

Part B.

Analytical results are shown in Table 3.

TABLE 3

| | | |
|---|---|---|
| Moisture g/100 g | 2.89 | g/100 g |
| Protein g/100 g | 61.02 | g/100 g |
| Fat by hydrolysis g/100 g | 16.34 | g/100 g |
| Ash for minerals g/100 g | 7.25 | g/100 g |
| Sodium - AA mg/100 g | 274.00 | mg/100 g |
| Total carbohydrates - calculated g/100 g | 12.50 | g/100 g |
| Energy Kcal/100 g | 441.0 | Kcal/100 g |
| Saturated fat (GC) g/100 g | 3.19 | g/100 g |

| | |
|---|---|
| Cholesterol (GC) mg/100 g | not detected |

### Example 2: Protein Recovery from Chickpea Flour

Chickpea flour having 91% dry matter and 22.5% protein content was mixed with water in a ratio of 1:1 to 1:10 at 50 to 60 degrees Celsius and caustic to a pH of 7.5 to 9.0 in an agitated tank. The slurry was then fed into a centrifuge to separate the insoluble starches from the protein extract (liquid). The starch obtained was rejected. The liquid extract was sent to another stirred tank to precipitate the protein by adding acid to achieve a pH of 3.5 to 4.5 at 50 to 55 degrees Celsius. The mixture was fed into a centrifuge to separate the protein concentrated from sugars (liquid).

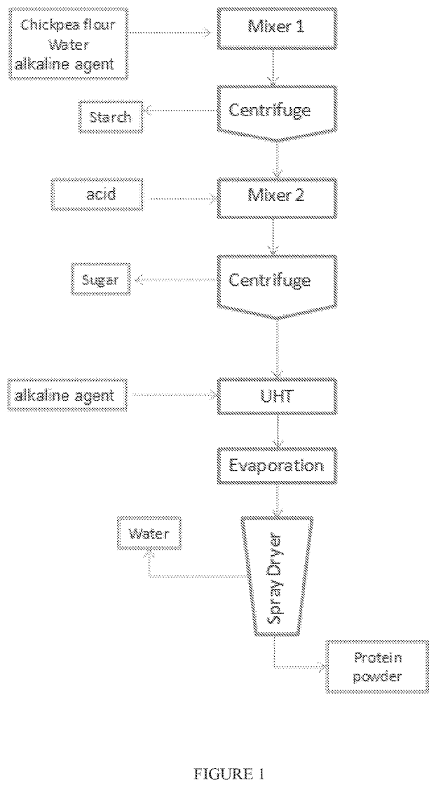

The sugar liquid by-product was directed to the drain and the protein curd solids were sent to the evaporator to adjust the solids content to 12% to 17%. After evaporating, the protein concentrated was adjusted to a neutral pH and heated to 75 to 90 degrees Celsius for 10 minutes to 40 minutes. Finally, the protein was fed to the spray dryer to produce the chickpea protein product. A flow-chart showing these steps is illustrated in FIG. 1.

The trials were divided in two trials with 2 batches each one. In the first trial, the protein concentrated was evaporated until about 8% to 9% in solid content and in the second trial the solid content achieved was about 13% to 15% and also the operation was optimized in order to reduce production cost.

Results

First Trial

Table 4 shows the composition of the raw material used in the trials.

TABLE 4

| Chickpea Flour | |
|---|---|
| Dry mat (%) | 94.70% |
| Moisture (%) | 5.30% |
| Nitrogen (%) | 3.93% |
| Protein (%) | 24.56% |

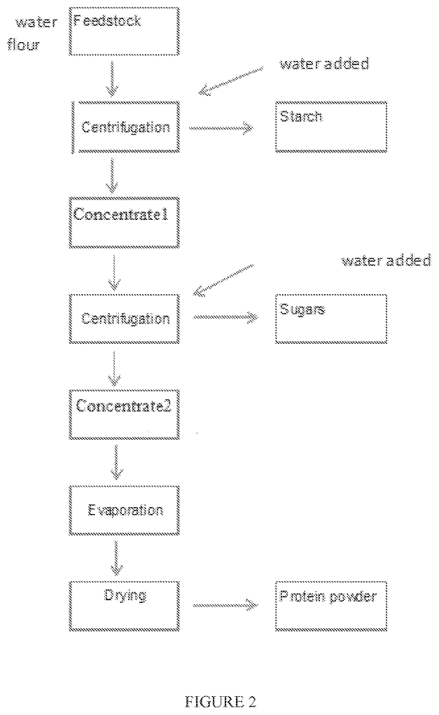

FIG. 2 shows a flow chart for the process used in the first trial.

Process yields are shown in Table 5:

TABLE 5

| Parameter | % Yield |
|---|---|
| Protein recovery from chickpea flour | 29.1% |
| Final product recovery from chickpea flour | 48.4% |

The production resulted by 60% protein purity. The protein yield was 29.1%.

### Example 3—Obtaining Protein Purity of 79%

Production Process:

2500 kg flour was dispersed in water at a ratio of 1:8 to 1:10 at to 50 to 55 degrees Celsius using a dissolving unit. The pH was adjusted to 7.5 to 9 with alkaline agent solution. The batch size was split into four batches of 6,250 kg each, and processed over two consecutive days.

Each batch was stirred for 10 minutes to 30 minutes and then the starch and fibers were separated from the liquid phase (protein solution) using a decanter. Protein was then precipitated out of solution using an acid solution, and separation of the protein precipitate from the liquid phase was performed.

The protein solids were re-dispersed using a 1:1.5 to 1:3 ratio of water. The washed protein solids were separated from the liquid phase using a decanter and the washed protein solids was re-dispersed using a sufficient amount of water to make a dispersion. The dispersion was neutralized with alkaline agent solution to a pH of about 7 of all batches together, and homogenized. The homogenized dispersion was heated at 65 degrees Celsius to 75 degrees Celsius and spray dried to form a powder. The powder was sieved using a mesh size of about 2 mm.

Table 6 shows the analytical results of the chickpea protein composition. The experiments for obtaining the analytical results were run two times (i.e., first results and second results).

| | Chickpea protein product | |
|---|---|---|
| | First results | Second results |
| Protein content (% w/w) | 55 | 57 |
| Carbohydrates (% w/w) | 12.6 | 16.8 |
| Fibres (% w/w) | n.d. | 4.1 |
| Ash (% w/w) | 7.7 | 7.7 |
| Fat (% w/w) | 18.6 | 15.9 |
| Dry Matter (% w/w) | 96.8 | n.d. |
| Moisture (% w/w) | 3.2 | 2.6 |
| Total plate count (cfu/g) | 17000/5000* | n.d. |
| Enterobacteriaceae (cfu/g) | <10 | n.d. |
| Salmonella | Absent in 25 g | n.d. |
| Bacillus cereus (cfu/g) | <10 | n.d. |
| Sulfite reducing anaerobes (cfu/g) | <10 | n.d. |

* Starting sample contained 17000 cfu/g, final sample contained 5000 cfu/g

### Example 4: Chickpea Protein Product Production

65 pounds of Chickpea Flour was mixed with water at 110 degrees Fahrenheit to 130 degrees Fahrenheit and alkaline agent to a pH of 7.5 to 9.0 in an agitated tank at a ratio of 1:1 to 1:10 of flour:water ratio for 10 to 40 minutes to make a slurry. The slurry was then fed into a centrifuge at a feed rate of 5 to 10 pounds/min to separate the insoluble Starch-Fiber into product (solids) and Protein Extract (liquid). Part of the solid fraction was re-hydrated with water and spray dried. The liquid extract was then precipitated by adding acid to a pH of 2.5 to 4.5 in an agitated tank at 110 degrees Fahrenheit to 130 degrees Fahrenheit. The mixture was held for 10 minutes to 30 minutes and then fed to a centrifuge. The Sugar Liquid by product (whey) was sampled and disposed to the drain. The protein curd solids were rehydrated with water and agitated followed by separation using a centrifuge. The Washed Liquid by product was sampled and disposed. The 2nd protein curd solids were modified by adjusting the solids level to 8% to 12% with water at 100 degrees Fahrenheit to 115 degrees Fahrenheit, and adjusting the pH to 5.5 to 7.5 with an alkaline agent to generate a neutralized slurry. The neutralized slurry was treated with an enzyme, agitated, and homogenized. The homogenized slurry was exposed to a temperature of 150 degrees Fahrenheit to 175 degrees Fahrenheit and separated into two parts. A first part was then spray dried to produce a chickpea protein product.

The second part was chilled overnight and used as is in the development of the protein drink.

In one of the above runs a non-hydrolyzed chickpea protein product was produced according to the same process conditions but without the enzyme reaction stage.

Low Fat Chickpea Protein Product Production:

An additional run was made to produce low fat chickpea protein product. In this process the protein extract produced in the above 3 repeated runs was delivered to a separator for separation of a fat-enriched cream fraction. The separator separated the fat-enriched fraction (Chickpea Cream) from a reduced-fat extract. The Chickpea Cream was collected for analysis and the reduced-fat extract was then precipitated, washed and heated without enzymes under the same conditions of the above examples of chickpea protein product production.

### Example 5: Protein Extraction from Pulses

The methods described are based on wet extraction for protein and relate to specific deviations and alteration of the wet extraction method so as to allow commercially available extraction method that allows for good protein recovery, favorable protein characteristics and cost effective process.

Process description: Wet extraction process that is generally used in the food ingredients industry typically includes using flour from pulse seeds (pulse flour) as raw material, exposing said flour to elevated pH value at elevated temperature so increase protein solubility, separating a non-soluble fraction by means of a centrifuge, exposing the liquid that includes soluble protein to acidic condition, so as to reduce protein solubility and separating the protein curd from the liquid fraction.

When such generic approach is applied to chickpea protein the protein yield is low and the process is expensive in relation to other commercially available protein obtained from legumes.

The following experiment revealed surprising results due to the following parameters, which relate to the raw material used, process parameters, introduction of enzymes and fragmented pH extraction method. For example, whole chickpeas were used in the subject process.

Whole chickpeas where soaked in cold water for 5 to 20 hours before the pH was increased to 6.5 to 8.5 and the temperature was increased to 45 to 60 degrees Celsius for 10 to 40 minutes, while maintaining a ratio of chickpea to water of 1:5 to 1:10. The chickpeas and the water were passed through a colloid mill to reduce particle size. The mixture was then agitated to sufficiently separate soluble material and non soluble material.

### Example 6: Characteristics of the Chickpea Protein Product Obtained by the Subject Methods

Chickpea Protein Product is a non-allergenic highly digestible plant protein produced from Non-GMO whole chickpea. The Chickpea Protein Product of the present invention can be used as an ingredient in the production of gluten-free pasta and baked goods, nutritional bars, ice cream, dairy alternatives, drinks and other food products. Table 7 below shows the analytical data of the chickpea protein product.

TABLE 7

| | |
|---|---|
| Typical Analytical Data | |
| Moisture (%): | <10 |
| pH: | 7 (+/−1) |
| Protein Content: | 65-70% or more |
| 1.1. General Characteristics | |
| Appearance: | Powder |
| Taste | Sweet characteristic |
| Odor | Characteristic |
| 1.2. Microbiological Control | |
| Total count | <10,000 |
| Molds % Yeast | <100 |
| E. coli | Absent in 1 gr. |
| Salmonella: | Absent in 25 gr. |
| 1.3. Allergen information | |
| Gluten Free, Soy Free, Dairy Free. | |
| 1.4. Labeling | |
| Chickpea protein, vegetable protein. | |

In the present example, 70% protein was recovered.

The shelf life of the chickpea protein product is between 12 and 18 months from the date of production when stored under typical dry, cool conditions in sealed package. The chickpea protein product can be stored in polyethylene bags.

### Example 7: Flavored Chickpea Based Protein Drink

The pasteurized protein paste from the Chickpea Protein Product runs was used as the protein source in the development of 3 flavors 8 Oz. protein drinks based on 6.25% protein.

A composition calculating chart and wide range of flavors, texturizers and other ingredients were used first at lab scale mixing to prepare the protein drink prototypes.

About 2 to 4 pounds of pre-mix was prepared by mixing sugars and the extra needed water at 100 degrees Fahrenheit to 120 degrees Fahrenheit with the addition of stabilizers (e.g., but not limited to, carrageenan, etc.), cocoa (e.g., the cocoa drink), and other flavors.

About 7 to 9 pounds of the chickpea protein paste at a temperature of 100 degrees Fahrenheit to 120 degrees Fahrenheit was mixed in a tank while gradually adding the above pre-mix until a homogenous mixture was generated (about 10 minutes). The mixed formula was fed through a homogenizer filling of 8 Oz bottles using an inline HEPA filtered hood.

Cocoa, vanilla and coffee flavored protein drinks were prepared accordingly.

Chemical Analysis:

Moisture/Dry Solids:

Samples collected from the above processes were analyzed for moisture/dry solids level using a CEM microwave moisture analyzer.

Protein Content:

Samples were analyzed according to the Kjeldahl protein analysis (protein factor 6.25%).

Fat Content:

Samples were analyzed using the Mojonnier, Acid Hydrolysis method to determine fat content of the dry Chickpea Protein Product and raw material.

Sugar Profile:

Samples were analyzed by HPLC sugar analysis including Stachyose and Raffinose.

Nutrition Value:

A complete nutrition value analysis was used for the protein drinks.

Table 8 represents moisture and protein composition of the raw material and each product or by-product produced in the Chickpea Protein Product runs.

TABLE 8

| | | | Fat % | |
|---|---|---|---|---|
| | Moisture | Protein % | (Acid | Sugars % |
| Product | % | (dry basis) | Hydrolysis) | (HPLC)* |
| Chickpea Flour | 9.2 | 24.9 | 6.8 | — |
| (Raw Material) | | | | |
| Chickpea Protein | 3.5 | 72 | 23.5 | <0.1 |
| Product | | | | |
| Low Fat Chickpea | 3.5 | 79.3 | 18.5 | — |
| Protein Product | | | | |
| Starch-Fiber (wet) | 65 | 4.0 | — | — |
| Starch-Fiber (dry) | 3.5 | 4.0 | — | — |
| Sugar Waste | 98.4 | 27.5 | — | — |

*all sugars including Stachiose & Raffinose were less than 0.1%

Conclusions:

The Chickpea Protein Product is soluble and it has high emulsion capacity. Therefore it can be used in the protein drink as the protein and fat source eliminating the need of external emulsifiers or added fat.

### Example 8: Use of Chickpea Protein Product

The chickpea protein product can be used as an ingredient when making, e.g., but not limited to, cereals, protein-enriched beverages, doughs for pastas, pizzas and bakery products, meat substitute products, and other protein based products.

### Example 9: Use of Chickpea Protein Product to Generate Emulsions

The chickpea protein product was used for the preparation of an emulsion (e.g., a mayonnaise-like product), avoiding the use of starch. Surprisingly, the resulting product formed a stable and strong emulsion having a smooth texture. The resulting product maintained its texture for more than 5 days in 4 degrees C. An example of the ingredients in the emulsion is shown in Table 9:

TABLE 9
Egg-Free Mayonnaise

| Ingredients | % |
|---|---|
| Oil | 70.0 |
| Water | 20.0 |
| Vinegar | 4.0 |
| Sugar | 3.0 |
| Chickpea protein product | 2.0 |
| Salt | 1.0 |
| Lemon concentrate | Less than 0.5% |
| Total | 100.0% |

To generate this emulsion, the dry ingredients (sugar, chickpea protein, salt) were mixed and added to the water and then stirred until dissolved. The oil was added gradually while stirring on high speed. Lastly, vinegar and lemon were added.

Flavors, such as mustard, garlic etc., may be added.

### Example 10: Use of a Lipase to Increase Protein Content

A lipase can be introduced to the chickpea and water mixture. The use of lipase in the process allows for the separation of the fatty acids from the glycerin backbone of the triglyceride formation, thus rendering the oil to protein association to be less effective and elevating the percentage of protein that may be extracted. Accordingly, prior to acid precipitation, a lipase can be added to this mixture and incubated for about 10 to 30 minutes at about 30 to 50 degrees Celsius while stirring.

For example, a lipase targeting linoleic acid can be used in the subject method and would hydrolyze chickpea fats. The chickpea fats would then be removed during subsequent alkaline and acidic treatment steps.

### Example 11: Serial pH Precipitation Steps

Multiple pH precipitation steps can be used in the subject method. In conventional wet protein extraction methodology, the process relays on the least soluble pH range to enable effective precipitation, the pH range for chickpea protein being between 3 and 6. The pH of the liquid fraction of the first centrifugation step is lowered to 5 for 10 minutes to 30 minutes at a temperature of 35 to 50 degrees Celsius and centrifuged to allow separation of the precipitated protein. The liquid fraction is treated with acid again so as to lower the pH to 4.5 for 10 to 30 minutes and centrifuged to allow separation of the precipitated protein. The liquid fraction is treated with acid a third time so as to lower the pH to 4 for 10 to 30 minutes and centrifuged to allow separation of the precipitated protein. The solid fractions from the 3 pH ranges treated are collected, water is added to these fractions, and the pH is neutralized before further processing, e.g., but not limited to, pasteurization, possibly homogenization and spray drying.

### Example 12: Chickpea Protein Product Compared to Soy Protein and Pea Protein

Testing was conducted on an embodiment of chickpea protein product of the present invention and comparative soy protein and pea protein products to evaluate emulsification activity, emulsification stability, water binding and oil binding according to the methods detailed in the Table 10 below.

TABLE 10

| Test | Instrument | Method |
|---|---|---|
| Dry Solids % | Sartorius | 105° C., 3-4 g |
| pH | pH meter | 6.6% solution |
| Emulsification | Homogenizer + | Emulsifying activity - create a 60% |
| Activity/Stability | centrifuge | oil emulsion + 2% protein, |
| | | centrifuge (4000 RPM, 7 min), |
| | | measure the height of the top oil layer |
| | | Emulsifying stability - put tube in |
| | | 80° C. for 15 min. centrifuge again, |
| | | measure top layer of oil |
| Foaming | Whisker | Whisk for one min. X% protein, |
| | | X% powder sugar. Foam expansion- |
| | | % of increase in volume. Foam |
| | | stability |
| Water Binding | Centrifuge | 10% protein in water, centrifuge |
| | | for 7 min, 4000 RPM |
| Oil Binding | Centrifuge | 10% protein in oil, centrifuge for 7 |
| | | min, 4000 RPM |

The results of the evaluation are shown in Table 11 below:

TABLE 11

| | Chickpea | Comparative | Comparative |
|---|---|---|---|
| Parameter | Protein Product | Soy Protein | Pea Protein |
| Emulsification activity | 99.4% | 98.6% | 97.1% |
| Emulsification stability | 98.6% | 85.7% | 91.4% |
| Water binding (g/g) | 4.11 | 6.56 | 3.80 |
| Oil binding (g/g) | 2.65 | 1.99 | 1.89 |

### Example 13: Comparison of Emulsified Food Products

In the following example, emulsified food products were produced using the chickpea protein product according to the present invention as the sole emulsifier in the product. Comparative emulsified food products were also analyzed to assess the amount of emulsifiers in the comparative emulsified food products. The results are shown in Table 12 below:

TABLE 12

| | | Total amount of | | Total Chickpea |
|---|---|---|---|---|
| | | emulsifiers and | | Protein Product |
| Comparative Emulsified | Emulsifiers | stabilizers added | | in parallel product |
| Food Product | and Stabilizers | (wt %) | | (wt %) |
| Leading Brand Mayonnaise | Egg | 7.4% | | 2% |
| Leading Brand Vegetarian mayonnaise | Modified food starch | 7.4% | | |
| | Pea protein | | | |
| Leading Brand Vegetarian mayonnaise | Modified food starch | 7.4% | | |
| Leading Brand Ice cream - dairy | Cream | 4% | proteins | 2% |
| | Skim milk | 1% | others | |
| | Egg yolks | | | |
| | Guar gum | | | |
| | Carrageenan | | | |
| Leading Brand Ice cream Veggie | Pea protein | 2% | proteins | |
| | Sunflower lecithin | ~10% | others | |
| | Corn starch | | | |
| | Guar gum | | | |
| | Locust bean gum | | | |
| | Carrageenan | | | |
| | Soy lecithin | | | |
| Leading Brand Pudding | Soya beans | 3.2% | proteins | 3% |
| | Modified Tapioca starch | 3.4% | others | |
| | Pectin | | | |
| | Carrageenan | | | |
| | Maltodextrin | | | |
| Leading Brand Pudding | Milk 81% | 2.9% | proteins | |
| | Corn starch | 1.5% | others | |
| | Carrageenan | | | |
| | Poly phosphate | | | |
| | Sodium Phosphate | | | |

The emulsified food products having the chickpea protein product according to embodiments of the present invention showed visually similar emulsification stability compared to the comparative emulsified food products. As shown in Table 12, emulsified food products having the chickpea protein product according to embodiments of the present invention require less emulsifiers for similar emulsification stability compared to comparative emulsified food products.

### Example 14: Foam Stability of the Chickpea Protein Product

A sufficient quantity of chickpea protein product was added to water to form 5 wt %, 10 wt % and 20 wt % solutions based on the total weight of the solutions.

Each solution was mixed using a mixer and wire whisk for 15 minutes and the volume of the resulting foam was measured. The 20 wt % solution resulted in no increase in foam volume, the 10 wt % solution resulted in a 200% increase in foam volume and the 5% solution resulted in a 300% increase in foam volume. The foam from the 10 wt % solution was stable while the foam from the 5% solution was broken after 30 minutes.

Additional foam testing was conducted using the 10 wt % solution at varying pH levels. The pH of the 10 wt % solution was adjusted using acid and alkaline agent to achieve a pH of 4, 5, 6, 7, 8, 9 or 10. Each solution was mixed using a mixer and wire whisk for 15 minutes and the volume of the resulting foam was measured. The results of the foam testing is shown in Table 13 below:

| | Foam Volume |
|---|---|
| pH | (% increase from initial foam volume) |
| 4 | 175 |
| 5 | 125 |
| 6 | 350 |
| 7 | 200 |
| 8 | 250 |
| 9 | 400 |
| 10 | 400 |

Thus, the highest foam volume increase was obtained at a pH of 9 and 10. The foam also exhibited good stability over time.

Additional foam testing was conducted using the 10 wt % solution at varying temperatures. The temperature of the 10 wt % solution was adjusted to 50 degrees Celsius, 60 degrees Celsius, 70 degrees Celsius and 80 degrees Celsius. Each solution was mixed at the elevated temperature using a mixer and wire whisk for 15 minutes and the volume of the resulting foam was measured. The results of the foam testing is shown in Table 14 below:

| Temperature | Foam Volume |
|---|---|
| (degrees Celsius) | (% increase from initial foam volume) |
| 50 | 550 |
| 60 | 650 |
| 70 | 700 |
| 80 | 500 |

Thus, the highest foam volume increase was obtained at a temperature of 70 degrees Celsius. The foam also exhibited good stability over time.

Additional foam testing was conducted using the 10 wt % solution with varying concentrations of powder sugar or sugar. A predetermined amount of sugar was added to the 10 wt % solution at a pH of 7 and then heated to 70 degrees Celsius while mixing using a mixer and wire whisk for 15 minutes. The volume of the resulting foam was measured. The results of the foam testing is shown in Table 15 below:

| Sugar | Foam Volume |
|---|---|
| (weight percent based on | (% increase from |
| total weight of solution) | initial foam volume) |
| 0.5 | 600 |
| 1 | 500 |
| 1.5 | 500 |
| 2 | 500 |

Additional testing was conducted using the 10 wt % solution with 0.5 wt % of powdered sugar. The 10 wt % solution with 0.5 wt % of powdered sugar was heated to 70 degrees Celsius while mixing using a mixer and wire whisk for varying mixing times. The volume of the resulting foam was measured. The results of the foam testing is shown in Table 16 below:

| Mixing Time | Foam Volume |
|---|---|
| (minutes) | (% increase from initial foam volume) |
| 15 | 350 |
| 30 | 200 |

Additional testing was conducted to evaluate foam stability over time using the 10 wt % solution with varying amounts and types of sugar. The 10 wt % solution with varying amounts and type of sugar was while mixing using a mixer and wire whisk for 15 minutes. The volume of the resulting foam was measured at various times after the mixing was complete. The results of the foam testing is shown in Table 17 below:

| | | % increase | % increase | % increase | % increase | % increase |
|---|---|---|---|---|---|---|
| Solution | | (0 min) | (15 min) | (30 min) | (45 min) | (60 min) |
| 0% | sugar | 400 | 400 | 400 | 400 | 380 |
| 0.5% | sugar | 350 | 350 | 350 | 300 | 300 |
| 0.5% | powdered sugar | 350 | 350 | 350 | 350 | 350 |

The variables showing the highest foam volume and stability are shown in Table 18 below:

| Variables | Highest Foam Volume | Highest Foam Stability |
|---|---|---|
| Temperature | 70 degrees Celsius | 70 degrees Celsius |
| pH | 6/9/10 | 9/10 |
| Powdered Sugar | 0 | 0.5% |
| Mixing time | 30 min with sugar/ | 30 min with sugar/ |
| | 15 min without sugar | 15 min without sugar |
| Continue foaming during | Yes | Yes |
| cooling, at mild velocity | | |
| Concentration | 5% | 10% |

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

While a number of embodiments of the present invention have been described, it is understood that these embodiments are illustrative only, and not restrictive, and that many modifications may become apparent to those of ordinary skill in the art.

1-19. (canceled)

20. A chickpea protein product comprising at least 50 w % chickpea protein and further comprising chickpea fat in a w % amount that is greater than its amount in raw chickpea flour, said chickpea protein product being in a form of a powder.

21. The chickpea protein product of claim 20, comprising at least 60 wt % chickpea protein.

22. The chickpea protein product of claim 20, having between 65 wt % protein to 95 wt % protein.

23. The chickpea protein product of claim 20, comprising less than 10% moisture, a pH of 7±1 and at least 65 wt % protein.

24. The chickpea protein product of claim 20, comprising at least 15.9% w/w fat.

25. The chickpea protein product of claim 20, for use as a food ingredient.

26. The chickpea protein product for use according to claim 20, wherein said chickpea protein product is used as an emulsifier.

27. An emulsified food product comprising the chickpea protein product of claim 20.

28. The emulsified food product of claim 27, being a vegan food product.

29. The chickpea protein product of claim 27, being free of externally added emulsifiers.
